(19) United States
(12) Patent Application Publication
(10) Pub. No.: US 2007/0291410 A1
(43) Pub. Date: Dec. 20, 2007

(54) Method of Manufacturing Perpendicular Magnetic Recording Medium and Perpendicular Magnetic Recording Medium

(75) Inventor: Masahiro Oka, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku,TOKYO (JP)

(21) Appl. No.: 11/665,752

(22) PCT Filed: Oct. 19, 2005
(86) PCT No.: PCT/JP05/19647

§ 371 Date: Apr. 19, 2007

Related U.S. Application Data
(60) Provisional application No. 60/622,701, filed on Oct. 28, 2004.

(30) Foreign Application Priority Data
Oct. 21, 2004 (JP) 2004-307186

(51) Int. Cl. G11B 5/851

(52) U.S. Cl. 360/126

(57) ABSTRACT

In order to increase a surface recording density by greatly increasing a track density with maintaining a recording and reproducing property which is not less than that of the prior art, a nonmagnetic substrate 11, target materials 12, and magnetic plates 21 are positioned in parallel in a thin-film coating apparatus 10. A high-frequency voltage is applied to the target materials, and different polarities spaced uniformly on the surfaces of the magnetic plates are alternately generated. A sputtering gas is introduced into the thin-film coating apparatus to generate plasma around the target materials. A thin layer is formed on the nonmagnetic substrate by a sputtering method.

### CROSS REFERENCE TO RELATED APPLICATIONS

Priority is claimed on Japanese Patent Application No. 2004-307186, filed Oct. 21, 2004. This application is an application filed under 35 U.S.C. §111(a) claiming pursuant to 35 U.S.C. §119(e) of the filing date of Provisional Application 60/622,701 on Oct. 28, 2004, pursuant to 35 U.S.C. §111(b).

### TECHNICAL FIELD

The present invention relates to a magnetic recording medium for use in a hard disk apparatus and the like, and particularly, relates to a perpendicular magnetic recording medium, a method of manufacturing the perpendicular magnetic recording medium, and a magnetic recording apparatus.

### BACKGROUND ART

Recently, there has been a noticeable increase in the application of magnetic recording apparatus such as a magnetic disk apparatus, a floppy (Registered trademark) disk apparatus, and a magnetic tape apparatus. The increasing importance of such apparatus is accompanied by a demand to noticeably improve the recording density of magnetic recording media used in these apparatus.

In particular, since the introduction of MR heads (Magneto Resistive Head) and PRML (Partial Response Maximum Likelihood) techniques, the recording density has increased markedly, and in recent years the introduction of GMR heads (Giant Magneto Resistive Head), TMR heads (Tunnel Magneto Resistive Head), and the like made it continue to increase at a pace of approximately 100% each year.

Thus there is a demand to achieve even higher recording density than hitherto, and accordingly to achieve a magnetic recording layer which has high coercivity, a high signal-to-noise ratio (SNR), and high resolution. In case of longitudinal magnetic recording systems which have been used widely, the demagnetization which weakens the adjacent recording bit becomes dominant as the linear recording density increases. To avoid this, the magnetic recording layer must be made even thinner to increase the magnetic shape anisotropy.

On the other hand, as the magnetic layer thickness becomes thinner, the energy barrier to keep the magnetic domain stable becomes comparable with thermal energy and it makes thermal fluctuation not negligible, which is said to decide the limit of the linear recording density.

In view of this, anti-ferromagnetically coupled (AFC) medium has recently been proposed as a technique for improving the linear recording density of longitudinal magnetic recording systems, and effort are being made to avoid thermal decay which is a problem in longitudinal magnetic recording.

Perpendicular magnetic recording techniques are attracting attention as one of the candidates to improve areal recording density in the future. In conventional longitudinal magnetic recording systems, the medium is magnetized horizontally, parallel to the surface of the medium. In contrast, in perpendicular magnetic recording systems, the medium is magnetized vertically, perpendicular to the surface of the medium.

It is thought that this makes it possible to avoid the effects of demagnetization, which is an obstacle to achieving high linear recording density in longitudinal magnetic recording systems, and is therefore ideal for high-density recording. Since the thickness of the magnetic layer can be kept constant, the effects of thermal decay, which is problematic in longitudinal magnetic recording, are thought to be comparatively small.

As shown in FIG. 1, perpendicular magnetic recording medium generally consists of a seed layer 2, an intermediate layer 3, a magnetic recording layer 4, and a protective layer 5, which are grown successively on a nonmagnetic substrate 1. A magnetic layer, which will be called a soft magnetic under layer, is interposed between the seed layer 2 and the nonmagnetic substrate 1. The purpose of the intermediate layer 3 is to enhance the characteristics of the magnetic recording layer 4. In addition, it is said that the seed layer 2 controls crystal orientations in the intermediate layer 3 and the magnetic recording layer 4 and controls shapes of magnetic crystals in the intermediate layer 3 and the magnetic recording layer 4 (For example, refer to Patent Document 1).

By the way, the crystal structure of the magnetic recording layer is important in manufacturing a perpendicular magnetic recording medium with excellent performances. In many perpendicular magnetic recording media, the crystal structure of the magnetic recording layer has a hexagonal close-packed (hcp) structure wherein it is important that the (002) crystal plane is parallel to the substrate surface; in other words, it is important that the crystal C axis ([002]) is aligned vertically with as little deviation as possible. However, while perpendicular magnetic recording media have an advantage of allowing use of a comparatively thick magnetic recording layer, they have a drawback that the total thickness of the stacked thin-film of the entire medium tends to be thicker than that of current longitudinal magnetic recording media, and this is liable to cause deviation of the crystal structure during the medium stacking process.

Although many efforts have been made at a deposition process in order to obtain a perpendicular magnetic recording medium with a excellent crystal structure, further technical improvement has been required in order to obtain excellent recording/reproducing characteristics. For example, a proposal has been made about a plasma processing apparatus which is capable of obtaining a uniform distribution of plasma over an entire wafer surface (For example, refer to Patent Document 2).

It is an object of the present invention to remarkably improve a crystal structure and to greatly increase a surface recording density in a perpendicular magnetic recording medium, which is expected to be a next-generation medium having a high recording density.

Patent Document 1: Japanese Unexamined Patent Publication No.2003-162807

Patent Document 2: Japanese Unexamined Patent Publication No. 2003-318165

### DISCLOSURE OF INVENTION

It is an object of this invention, in a perpendicular magnetic recording medium attracting attention as a next-generation high recording density medium technique, to markedly improve the crystal structure and thereby substantially increase the surface recording density.

(1) A method is provided for manufacturing a perpendicular magnetic recording medium having a structure in which a under layer and a magnetic recording layer are deposited on a nonmagnetic substrate. A thin-film coating process for forming at least one of layers of the perpendicular magnetic recording medium comprises the steps of positioning target materials on both sides of the nonmagnetic substrate and magnetic plates on surfaces of the target materials that are opposite to the nonmagnetic substrate in parallel in a thin-film coating apparatus, applying a high-frequency voltage to the target materials, alternately generating different polarities spaced uniformly on the surfaces of the magnetic plates, and introducing a sputtering gas into the thin-film coating apparatus to generate plasma around the target materials and to form a thin layer on the nonmagnetic substrate by a sputtering method.

(2) According to the present invention, the method is provided for manufacturing a perpendicular magnetic recording medium, wherein a plasma density near the nonmagnetic substrate positioned in the thin-film coating apparatus is not less than 1×10 ¹¹ cm ⁻³.

(3) According to the present invention, the method is provided for manufacturing a perpendicular magnetic recording medium, wherein a high-frequency voltage bias may be applied to the nonmagnetic substrate.

(4) According to the present invention, the method is provided for manufacturing a perpendicular magnetic recording medium, wherein a direct current voltage may be applied to each of the target materials together with the high-frequency voltage.

(5) According to the present invention, the method is provided for manufacturing a perpendicular magnetic recording medium, wherein a frequency of the high-frequency voltage applied to each of the target materials may be higher than a frequency of the high-frequency voltage bias applied to the nonmagnetic substrate.

(6) According to the present invention, the method is provided for manufacturing a perpendicular magnetic recording medium, wherein each of the magnetic plates may be subjected to rotation.

(7) According to the present invention, the method is provided for manufacturing a perpendicular magnetic recording medium, wherein the partial pressure of the sputtering gas may be not less than lPa and may be less than 8 Pa on forming a layer.

(8) According to the present invention, a perpendicular magnetic recording medium is provided manufactured by using any one of the above-mentioned methods (1) to (7) for manufacturing the perpendicular magnetic recording medium. The perpendicular magnetic recording medium has a surface average roughness Ra which is not greater than 4 angstroms.

(9) According to the present invention, a perpendicular magnetic recording medium is provided, wherein a distribution of in-plane film thickness is not wider than ±10% in a total film thickness of all thin layers of the perpendicular magnetic recording medium.

(10) According to the present invention, a perpendicular magnetic recording medium is provided, wherein the magnetic recording layer or the under layer has a crystal structure of a hexagonal close-packed structure and a half-width angle (Δθ50) is not greater than 50 in a Rocking curve corresponding to a (002) surface.

(11) According to the present invention, there is provided a perpendicular magnetic recording medium composed of an under layer and a magnetic recording layer which are deposited on a nonmagnetic substrate. The perpendicular magnetic recording medium has a surface average roughness Ra which is not greater than 4 angstroms. (12) According to the present invention, a perpendicular magnetic recording medium is provided, wherein a distribution of in-plane film thickness may be not wider than ±10% in a total film thickness of all thin layers of the perpendicular magnetic recording medium.

(13) According to the present invention, a perpendicular magnetic recording medium is provided, wherein the magnetic recording layer or the under layer has a crystal structure of a hexagonal close-packed structure and a half-width angle (Δθ50) is not greater than 5° in a Rocking curve corresponding to (002) surface.

(14) According to the present invention, there is provided a magnetic recording apparatus comprising a perpendicular magnetic recording medium described above (8) to

(13), a magnetic head having a recording part and reproducing part, devices for relatively moving the magnetic head against the perpendicular magnetic recording medium, and recording/reproducing signal processing devices for inputting a signal to the magnetic head and for reproducing an output signal supplied from the magnetic head.

According to the present invention, it is possible to obtain a perpendicular magnetic recording medium having a excellent high recording density characteristic, inasmuch as the C-axis of the crystal structure, more particularly, the hexagonal close-packed structure is aligned with respect to the substrate surface with a very small angle dispersion.

### BRIEF DESCRIPTION OF THE DRAWINGS

FIG. 1 shows a cross-sectional structural view of an example of a perpendicular magnetic recording medium of this invention.

FIG. 2 shows a configuration illustrating a thin-film coating apparatus used in a method of the present invention;

FIG. 3 shows a view illustrating an arrangement of magnets in a magnetic plate which is provided in the thin-film coating apparatus illustrated in FIG. 2; and

FIG. 4 shows a configuration illustrating a magnetic recording apparatus having the magnetic recording medium which is obtained by the method of the present invention.

### BEST MODE FOR CARRYING OUT THE INVENTION

A description will be made as regards a method of manufacturing a perpendicular magnetic recording medium according to an example of the present invention.

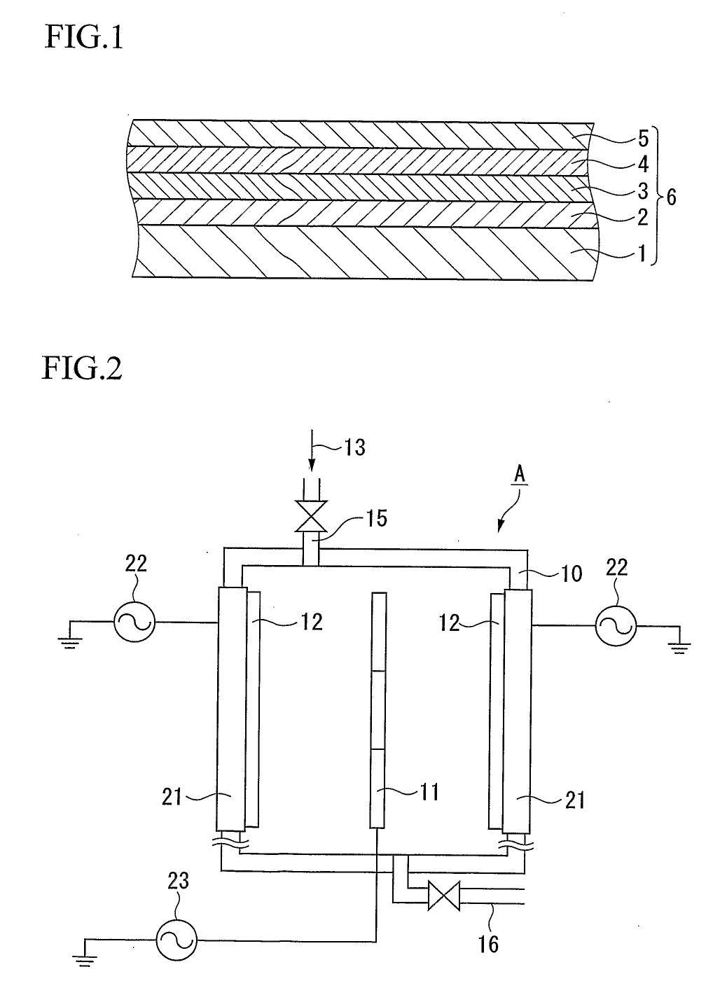

FIG. 1 shows a general layer structure of the perpendicular magnetic recording medium.

In the magnetic recording medium used in the present invention, the structure of a perpendicular magnetic layer is applicable to all magnetic recording media which are widely used at present. As shown in FIG. 1, a magnetic recording medium 6 according to the present example has a structure in which a seed layer 2, an intermediate layer 3, a magnetic recording layer 4, and a protective layer 5 are deposited on a nonmagnetic substrate 1 in ascending order.

The nonmagnetic substrate 1 for use in the magnetic recording medium of the present invention may be an Al alloy substrate such as an Al—Mg alloy having Al as the main component. Alternatively, the nonmagnetic substrate 1 may be a substrate which is composed of one selected from a usual soda glass, an aluminosilicate glass, an amorphous glass, silicon, titanium, ceramics, and types of resins. At any rate, it is possible to use types of nonmagnetic materials as the nonmagnetic substrate. More particularly, it is preferable to use the Al alloy substrate or a glass substrate such as a crystallized glass substrate.

In a manufacturing process of a magnetic disk, the substrate is usually washed and dried at first. It is desirable to wash and dry the substrate in the present invention before forming each layer on the substrate, in order to provide adequate adherence in each layer. In addition, the size of the substrate is not limited.

Next, a description will be made of each layer of the perpendicular magnetic recording medium 6.

A soft magnetic under layer, which is formed as an under layer for the seed layer 2 on the nonmagnetic substrate 1, is used in most general perpendicular magnetic recording media. On recording a signal on the medium, the soft magnetic under layer introduces a recording magnetic field from a head and efficiently applies the perpendicular component of a recording magnetic field to the magnetic recording layer 4. It is possible to use a material having a so-called soft magnetic property such as a FeCo alloy, CoZrNb alloy, or CoTaZr alloy, as a material of the soft magnetic under layer. Not only a single-layer structure but also a multi-layer structure may be used as the soft magnetic under layer. In the multi-layer structure, a very thin nonmagnetic film such as Ru is interposed between soft magnetic layers, in order to provide an antiferromagnetic coupling between the soft magnetic layers. Although the soft magnetic under layer has a layer thickness between about 2 nm to 20 mn, the layer thickness is appropriately determined on the basis of a balance between a recording-reproducing property and an OW (Over-Write) property. Preferably, the layer thickness is between about 5 nm and 15 nm in the soft magnetic under layer.

The seed layer 2 is a very important layer on which a magnetic property and a recording-reproducing property are dependent in the magnetic recording layer. The seed layer 2 acts to epitaxially grow each of the intermediate layer 3 and the magnetic recording layer 4 to a hexagonal close-packed structure. Pd may be used as a material of the seed layer 2.

The intermediate layer 3 is for use in perpendicularly orienting the magnetic recording layer 4 with efficiency. The intermediate layer 3 has a hexagonal close-packed structure and is for epitaxially growing the magnetic recording layer 4. It is very important to control the orientation of the intermediate layer 3 when manufacturing the perpendicular magnetic recording medium, inasmuch as a crystal orientation of the intermediate layer 3 almost determines the crystal orientation of the magnetic recording layer.

The magnetic recording layer 4 is a layer for literally recording a signal. For example, CoCr, CoCrPt, CoCrPt—O, CoCrPt—SiO₂, or CoCrPt—Cr₂O₃ is used as a material of the magnetic recording layer 4. Finally, the recording-reproducing property is determined by a crystal structure and a magnetic property of the magnetic recording layer 4.

A usual DC sputtering method or RF sputtering method is used for depositing each layer described above. Although the gas pressure is appropriately determined for each of the layers on deposition, the gas pressure is controlled to a range between about 0.1 Pa and 2.0 Pa while confirming the performance of the medium.

The protective layer 5 is for protecting the medium from damage due to contact of the head and the medium. For example, a carbon film or a SiO₂ film is used as the protective layer 5. In general, the carbon film may be used as the protective layer 5. Although a sputtering method or a plasma CVD method is used for forming the protective layer, the plasma CVD method has most often been used in recent years. The protective layer 5 has a layer thickness between about 1 nm and 10 nm. Preferably, the protective layer 5 has a layer thickness between about 2 nm and 6 nm. More preferably, the protective layer 5 has a layer thickness between 2 nm and 4 nm.

In the method of manufacturing the perpendicular magnetic recording medium according to the present invention, it is possible to enhance the performance of the medium by improving a forming process of the perpendicular magnetic recording medium. More specifically, it is possible to enhance the crystal orientation of magnetic recording layer when improving the forming process of the perpendicular magnetic recording medium. As a consequence of making every effort regarding the manufacturing method, it was found that it is possible to greatly enhance the performance of the medium in the case where an improvement is made to the sputtering method on forming at least one of the seed layer and the intermediate layer. As a result, the present inventor has invented the present invention.

A description will be given of the method of manufacturing the perpendicular magnetic recording medium according to the present invention, with reference to FIG. 2. The following improvement is made to a sputtering process in the present invention.

FIG. 2 shows an example of a manufacturing apparatus for use in the method of manufacturing the perpendicular magnetic recording medium according to the present invention. As shown in FIG. 2, target materials 12 are positioned on both sides of a nonmagnetic substrate 11 in parallel and magnetic plates 21 are positioned on surfaces of the target materials 12 that are opposite to the nonmagnetic substrate 11 in parallel in the thin-film coating apparatus 10. The target materials 12 are supplied with a high-frequency voltage from a radio frequency power supply 22.

In addition, the nonmagnetic substrate 11 is connected to a radio frequency power supply 23, in order to supply a high-frequency voltage bias to the nonmagnetic substrate 11. The target materials 12 may be supplied with a direct current voltage together with the high-frequency voltage applied from the radio frequency power supply 22. A sputtering gas is introduced into the thin-film coating apparatus 10 in order to generate plasma around the target materials 12 and to form a thin layer on the nonmagnetic substrate 11 by the sputtering method.

It is preferable to supply the nonmagnetic substrate 11 with the high-frequency voltage bias of a range between 5 MHz and 400 MHz, from the radio frequency power supply 23. In addition, it is preferable that the high-frequency voltage supplied to the target materials 12 is higher in frequency than the high-frequency voltage bias supplied to the nonmagnetic substrate 11. More specifically, it is preferable to supply the target materials 12 with the high-frequency voltage of 60 MHz, in case of supplying the nonmagnetic substrate 11 with the high-frequency voltage bias of 13.56 MHz.

Each of the magnetic plates 21 is positioned on the back surfaces of each of target materials 12. Each of the magnetic plates 21 acts in a manner similar to operation of usual magnetron sputtering at base.

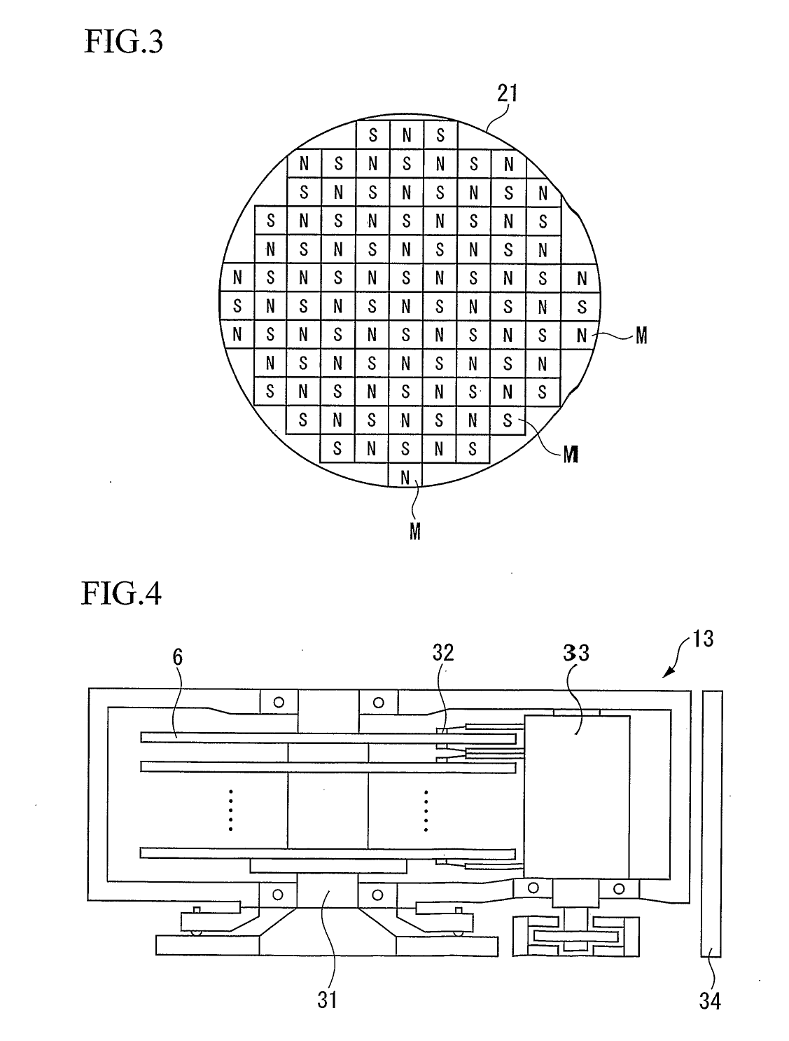

Incidentally, small magnets M are positioned to make a grid on the surface of magnetic plate 21 so as to alternately generate different polarities spaced uniformly as shown in FIG. 3. The distribution of magnetic flux becomes fine and complex. Inasmuch as a plurality of magnets M produces a fine magnetic field on the target materials 12, a high magnetic field strength occurs near the target materials 12 and plasma has a high density. For example, it is possible to generate the plasma having the density which is not less than 1×10¹¹ cm⁻³. Therefore, it is possible to uniformly release sputtering particles with the high ion density. In addition, it is possible to further uniformly deposit the layers when making the magnetic plate 21 positioned at above-mentioned state rotate around the axis of magnetic plate 21.

In the present invention, it is possible to ionize more particles by the fine magnetic field and the high-frequency voltage supplied to the target materials 12. As a result, it is possible generate the plasma having the density which is not less than 1×10¹¹ cm⁻³ which is impossible to be accomplished in the usual sputtering method. Accordingly, it is possible to obtain high film coverage, a high crystal orientation, and a high directivity.

By the manufacturing method using the sputtering method of the present invention, the inventor has found that it is possible to form the layers each of which has a high surface smoothness, in addition to the above-mentioned characteristics. More particularly, it is noted that it is possible to further improve the C axis orientation in the hexagonal close-packed structure of Co when forming the under layer positioned under the magnetic recording layer 4 by using the above-mentioned thin-film coating method, in the perpendicular magnetic recording medium whose crystal growth is susceptible to smoothness of a base substance.

Furthermore, it is possible to obtain a stable discharge under the sputtering gas pressure which is higher than a usual gas pressure. As a result, it is possible to form thin layers each of which has a high uniformity of layer thickness and a high homogeneity. In general, the gas pressure is between about 0.1 Pa and 20.0 Pa on forming a layer. Preferably, the gas pressure is between 0.5 Pa and 10.0 Pa. More preferably, the gas pressure is between 1.0 Pa and 8.0 Pa.

Each of the small magnets M used in the magnetic plate 21 of the present invention preferably has a size between about 5 mm and 30 mm. Each of the small magnets may be, for example, rectangular or circular in cross section. As described above, the small magnets M are positioned with a grid shape so as to alternately generate different polarities spaced uniformly. The distance (center to center) between the magnets M may be between about 0 mm and 50 mm.

Generally using a maximum value dₘₐₓ and a minimum value dₘᵢₙ of the layer thicknesses measured at in-plane points which is not less in number than three, an in-plane distribution δ of layer thickness is given by:
δ=(dₘₐₓ−dₘᵢₙ)/(dₘₐₓ+dₘᵢₙ)

By using the above-mentioned sputtering method, the layer thickness distribution of each layer, which is a component of the magnetic recording medium 6, is improved in comparison to a usual sputtering method. As a result, it is possible to make the layer thickness distribution be equal to or less narrow than ±10%.

The sputtering method given the above-mentioned devisal will be called an improved sputtering method, in order to simplify the following description.

When forming each layer by using the improved sputtering method, factors, which disturb the crystal structure in each layer on forming each layer, are controlled into minimum limits. As a result, it is possible to remarkably improve the C axis orientation in the magnetic recording layer 4. Although it is preferable to apply the above-mentioned method to both of the seed layer 2 and the intermediate layer 3, it is possible to obtain a certain effect even if the above-mentioned method is applied to one of the layers that may be the seed layer 2, the intermediate layer 3, or the soft magnetic under layer positioned under the seed layer 2. Therefore, the present invention includes applying the above-mentioned method to one of the layers which are components of the magnetic recording medium.

FIG. 4 shows an example of a magnetic recording and reproducing apparatus having the magnetic recording medium which has the above-mentioned deposited structure. In the example being illustrated, the magnetic recording and reproducing apparatus B comprises the magnetic recording medium 6 described above, a spindle motor 31 for making the magnetic recording medium 6 rotate, a magnetic head 32 for recording information on the magnetic recording medium 6 and for reproducing the information from the magnetic recording medium 6, a head actuator 33, and a recording/reproducing signal processing system 34. The recording/reproducing signal processing system 34 is for processing the inputted data to deliver a record signal to the magnetic head 32 and is for processing the reproduction signal supplied from the magnetic head 32, to output the data.

Inasmuch as the magnetic recording medium 6 having the above-mentioned structure comprises the layers each of which has the high property described above, it is possible to provide the magnetic recording and reproducing apparatus having a large storage capacity by effectively using the recording density property of the magnetic recording medium 6.

Next, description will be made about a specific example of the present invention A glass substrate for hard disk is set in a vacuum chamber which is evacuated of air in advance until the degree of vacuum is not greater than 1.0×10⁻⁵ Pa. In the glass substrate, a crystallized glass may be used as a material which is composed of Li₂Si₂O₅, Al₂O₃+K₂O, MgO+P₂O₅, and Sb₂O₃+ZnO. The glass substrate has an outer diameter of 65 mm, an internal diameter of 20 mm, and a surface average roughness which is not greater than 5 angstroms.

Using the sputtering method, the soft magnetic under layer is formed on the glass substrate in a thickness of 100 nm. The processed glass substrates of ten sheets are temporally retrieved from the chamber to be in storage.

Five sheets of the processed glass substrates are selected from the stored glass substrates and are set in the vacuum chamber which has been evacuated until 1.0×10⁻⁵ Pa. Furthermore, the seed layer (Pd) of 6 nm and the intermediate layer (Ru) of 200 nm are formed on each of the processed glass substrates in an ascending order by using the improved sputtering method.

In the improved sputtering method, an electrode used in the sputtering process is circular and has a diameter of 420 mm. Nd—Fe—B magnets, each of which has a size of 10×10×12 mm³ and whose magnetic flux density is 12.1 kG near the magnetic pole, are positioned on an entire surface of electrode in a grip shape in which the magnets are apart from one another in a distance of 40 mm. At that time, the adjacent magnetic poles are opposite in a direction to one another. In addition, an RF power source of 60 MHz is connected to the electrode and supplies the electrode with the power of 1000 W. The Ar partial pressure is adjusted to 1.3 Pa.

Next, the magnetic recording layer of 10 nm is formed by using the usual sputtering method and the DLC (Diamond Like Carbon) of 5 nm is formed by using the plasma CVD in each of the processed glass substrate, in order to obtain the magnetic recording media of five sheets. The magnetic recording media will be called examples 1 to 5, respectively.

Similarly, remaining five processed glass substrates each of which has CoNbZr layer are set in another vacuum chamber which has been evacuated of air until the degree of vacuum is not greater than 1.0×10⁻⁵ Pa. In order to obtain magnetic recording media, the seed layer (Pd), the intermediate layer (Ru), and the magnetic recording layer (CoCrPt—SiO₂) each of which has a thickness similar to the thickness of each example are formed on each of the processed substrates, by using the DC sputtering method. The magnetic recording media will be called comparison examples 1 to 5, respectively.

On manufacturing the examples 1 to 5 and the comparison examples 1 to 5, each of the glass substrates is not subjected to heating treatment and Ar gas is used as the sputtering gas. On forming the seed layer and the intermediate layer in each of the examples 1 to 5, the partial pressure of Ar gas is adjusted to 5.0 Pa. The partial pressure of Ar gas is adjusted to 0.5 Pa on forming the other layers in each of the examples 1 to 5. The partial pressure of Ar gas is adjusted to 0.5 Pa on forming all of the layers in each of the comparison examples 1 to 5.

In each of the examples 1 to 5 and the comparison examples 1 to 5, a Rocking curve is measured with respect to a peak corresponding to Co (002) by using an X-ray diffraction, in order to obtain the half-width (Δθ50) of Rocking curve.

In each of the examples 1 to 5 and the comparison examples 1 to 5, a perpendicular coercive force Hc ⊥ is measured by using a Kerr loop measuring device for perpendicular magnetic medium.

In each of the examples 1 to 5 and the comparison examples 1 to 5, an average surface roughness is measured by using a stylus surface roughness meter.

In each of the examples 1 to 5 and the comparison examples 1 to 5, the magnetic recording medium is set in a spinning stand for use in estimating a magnetic disk, and the recording and reproducing property is measured by using a perpendicular magnetic recording head. More particularly, measurement is carried out with respect to PW50 which is a pulse half-width of record signal and with respect to Sp-SNR which is strongly relative to a bit error rate.

The following Table 1 represents the measurement results of the examples 1 to 5 and the comparison examples 1 to 5. The plasma density in Table 1 was measured by using a single Langmuir probe.

TABLE 1

| | Plasma Density | | | | | |
|---|---|---|---|---|---|---|
| | near Substrate | Δθ50 | Hc⊥ | Ra | PW50 | Sp-SNR |
| | [cm⁻³] | [°] | [Oe] | [Å] | [nsec] | [dB] |
| Example 1 | 1.1 × 10¹¹ | 2.50 | 4563 | 3.2 | 7.0 | 27.3 |
| Example 2 | 1.1 × 10¹¹ | 2.81 | 4602 | 3.3 | 6.9 | 27.4 |
| Example 3 | 1.1 × 10¹¹ | 2.74 | 4533 | 3.4 | 7.0 | 27.1 |
| Example 4 | 1.1 × 10¹¹ | 2.79 | 4510 | 3.0 | 7.1 | 27.3 |
| Example 5 | 1.1 × 10¹¹ | 2.49 | 4632 | 3.4 | 6.8 | 27.5 |
| Comparison Example 1 | 5.0 × 10¹⁰ | 5.93 | 4501 | 4.6 | 7.4 | 27.0 |
| Comparison Example 2 | 5.0 × 10¹⁰ | 6.43 | 4497 | 4.5 | 7.3 | 26.9 |
| Comparison Example 3 | 5.0 × 10¹⁰ | 5.98 | 4479 | 4.5 | 7.6 | 26.9 |
| Comparison Example 4 | 5.0 × 10¹⁰ | 6.33 | 4500 | 4.5 | 7.6 | 26.8 |
| Comparison Example 5 | 5.0 × 10¹⁰ | 5.57 | 4532 | 4.6 | 7.5 | 26.7 |

As understood from the Table 1, the half-width (Δθ50) of Rocking curve, which is a precept with respect to the crystal orientation of perpendicular magnetic recording medium, becomes greatly narrow in each of the examples 1 to 5. It is noted that the crystal growth of Co is improved by using the improved sputtering method. Furthermore, each of the examples 1 to 5 has the coercive force which is slightly higher than the coercive force of each of the comparison example 1 to 5. In the recording and reproducing property, each of the examples 1 to 5 has a low half-width (PW50) with respect to the record signal and has a high Sp-SNR which is strongly relative to the bit error rate. It is noted that each of the examples 1 to 5 is ideal as the perpendicular magnetic recording medium.

In each of the examples 1 to 5 shown in Table 1, it is possible to obtain the perpendicular magnetic recording medium whose Δθ50 is not greater than 3° (2.49 to 2.81°) and whose Ra is not greater than 4 angstroms (3.0 to 3.4 angstroms).

### INDUSTRIAL APPLICABILITY

According to the present invention, it is possible to obtain a perpendicular magnetic recording medium having a excellent high recording density property, inasmuch as the C-axis of the crystal structure, more particularly, the hexagonal close-packed structure is aligned with respect to the substrate surface with a very small angle dispersion.

1. A method of manufacturing a perpendicular magnetic recording medium having a structure in which an under layer and a magnetic recording layer are deposited on a nonmagnetic substrate, wherein a thin-film coating process for forming at least one of layers of said perpendicular magnetic recording medium comprises the steps of:
positioning said nonmagnetic substrate, target materials on both sides of said nonmagnetic substrate, and magnetic plates on surfaces of said target materials that are opposite to said nonmagnetic substrate, in parallel in a thin-film coating apparatus;
applying a high-frequency voltage to said target materials;
alternately generating different polarities spaced uniformly on the surfaces of said magnetic plates; and
introducing a sputtering gas into said thin-film coating apparatus to generate a plasma around said target materials and to form a thin layer on said nonmagnetic substrate by a sputtering method.

2. A method of manufacturing a perpendicular magnetic recording medium as claimed in claim 1, wherein a plasma density near said nonmagnetic substrate positioned in said thin-film coating apparatus is not less than 1×10¹¹ ⁻³.

3. A method of manufacturing a perpendicular magnetic recording medium as claimed in claim 1, wherein a high-frequency voltage bias is applied to said nonmagnetic substrate.

4. A method of manufacturing a perpendicular magnetic recording medium as claimed in claim 1, wherein a direct current voltage is applied to each of said target materials together with said high-frequency voltage.

5. A method of manufacturing a perpendicular magnetic recording medium as claimed in claim 3, wherein a frequency of said high-frequency voltage applied to said each of said target materials is higher than a frequency of said high-frequency voltage bias applied to said nonmagnetic substrate.

6. A method of manufacturing a perpendicular magnetic recording medium as claimed in claim 1, wherein each of said magnet plates is subjected to rotation.

7. A method of manufacturing a perpendicular magnetic recording medium as claimed in claim 1, wherein the partial pressure of said sputtering gas is not less than 1 Pa and is less than 8 Pa on forming a layer.

8. A perpendicular magnetic recording medium manufactured by using the method of manufacturing the perpendicular magnetic recording medium claimed in claim 1, wherein said perpendicular magnetic recording medium has a surface average roughness Ra which is not greater than 4 angstroms.

9. A perpendicular magnetic recording medium as claimed in claim 8, wherein a distribution of in-plane film thickness is not wider than ±10% in a total film thickness of all thin layers of said perpendicular magnetic recording medium.

10. A perpendicular magnetic recording medium as claimed in claim 8, wherein:
said magnetic recording layer or said under layer has a crystal structure of hexagonal close-packed structure; and
a half-width of the Rocking curve (Δθ50) being not greater than 5° corresponding to (002) surface.

11. A perpendicular magnetic recording medium composed of an under layer and a magnetic recording layer which are deposited on a nonmagnetic substrate, wherein said perpendicular magnetic recording medium has a surface average roughness Ra which is not greater than 4 angstroms.

12. A perpendicular magnetic recording medium as claimed in claim 11, wherein a distribution of in-plane film thickness is not wider than ±10% in a total film thickness of all thin layers of said perpendicular magnetic recording medium.

13. A perpendicular magnetic recording medium as claimed in claim 11, wherein:
said magnetic recording layer or said under layer has a crystal structure of hexagonal close-packed structure; and
a half-width of the Rocking curve (Δθ50) being not greater than 5° corresponding to (002) surface.

14. A magnetic recording apparatus comprising:
a perpendicular magnetic recording medium claimed in claim 8;
a magnetic head having a recording part and reproducing part;
a device relatively moving said magnetic head against said perpendicular magnetic recording medium; and
a recording/reproducing signal processing device for inputting a signal to said magnetic head and for reproducing a output signal supplied from said magnetic head.
